(19) United States
(12) Patent Application Publication
(10) Pub. No.: US 2006/0180715 A1
(43) Pub. Date: Aug. 17, 2006

(54) Hanger rod stiffening clip

(76) Inventor: Daniel C. Duggan, St. Louis, MO (US)

Correspondence Address: William B. Ritchie;Law Office of William B. Ritchie, 1411 Northern Heights Drive NE, Rochester, MN, 55906-4045, US

(21) Appl. No.: 11/057,572

(22) Filed: Feb. 14, 2005

(51) Int. Cl. F16L 3/00

(52) U.S. Cl. 248/65

(57) ABSTRACT

A preformed hanger rod stiffening clip that improves the strength and stability of hanger rods to withstand compression forces. Precisely position screw holes enable the clamping legs of the clip to close completely when the fastening assembly is tightened. Washers on each side of the respective clamping legs deform the legs tightly around the stiffening member and the hanger rod which is disposed between the stiffening member and fastening assembly. It has been found that hole placement for a screw that is used to tighten the apparatus onto the hanger rod and stiffening member is critical. Misalignment of position of the screw openings greater than or equal to 0.001 inches results in a clip that will fail standard AISC compression tests.

### FIELD OF THE INVENTION

This invention relates to construction hardware, in particular, an apparatus to stabilize and strengthen hanger rods against buckling when the rods are used for supporting pipes, conduits or similar structures found in building construction in the face of unexpected movement as would be experienced in an earthquake.

### BACKGROUND OF THE INVENTION

A hanger rod is part of a typical hanger assembly wherein one end of a threaded rod is vertically attached to the building structure and the other end has an attachment mechanism such as a yoke which is used to connect to the part that is to be supported such as water pipes. While these rods can be provided in any diameter, the typical size is either ⅜, ½, ⅝, ¾, ⅞, 1 or 1¼ depending on the structure that is to be supported. The lengths can be selected as needed for the particular construction project with less than 120 inches being typical.

Various structures and methods have been proposed to strengthen the hanger rod against deformation due to unusual stresses. Most of such devices make use of a stiffening channel strut, angle iron or pipe that is positioned substantial parallel to the hanger rod. Connection of the stiffening member can be provided by actually welding the member to the rod, however, this is extremely time-consuming and not practical due to the expense involved.

U.S. Pat. No. 6,783,104 discloses and claims a deformable clip that connects the stiffening pipe to the hanger rod. This device has the advantage of being low cost and relatively easy to install. However, testing by the inventors have found that this arrangement will buckle quite easily unless the location of the holes are held to very close tolerances contrary to the teachings found in the '104 patent. The '104 patent teaches the use of a carriage bolt to tighten the clip in place. Further, the use of a carriage bolt prevents the legs of the clip from being tightened against one another. This device requires that the stiffening pipe to be placed between the hanger rod and the attachment mechanism. The design flaws in this device result in clip failure unless a substantial greater number of them are utilized.

A hanger rod stiffening clip that can be easily attached, is inexpensive to produce and can be spaced at 24″ clip spacing for ⅜″ hanger rod from one clip to the next along the stiffening pipe, which is equal to the governing least radius of gyration ratio for ⅜″ hanger rod to resist buckling, and can withstand compression force of at least 325 pounds on a test apparatus using a 120 inch long hanger rod in a typical installation, is not found in the prior art. A ⅜″ hanger rod that is 24″ long and is tested without stiffener clips will buckle at 125 pounds of compression pressure on the test apparatus.

### SUMMARY OF THE INVENTION

It is an aspect of the invention to provide a hanger rod stiffening clip that can be manufactured from malleable galvanized straps to a precise tolerances using stamping techniques well known in the art.

It is another aspect of the invention to provide a hanger rod stiffening clip that can fit a plurality of hanger rod sizes.

It is still another aspect of the invention to provide a hanger rod stiffening clip that has a preformed tapered shape that will keep the clip in position on the hanger rod and associated stiffening pipe until the clip can be firmly tightened.

Another aspect of the invention is to provide a hanger rod stiffening clip that can be spaced in accordance with AISC formulas which are well known in the art and which provides a substantial increased resistance to buckling than is experienced with unstiffened rods.

Another aspect of the invention is to provide a hanger rod stiffening clip such that as the screw that pulls the legs of the clip are tightened, the clip urges the hanger rod which is disposed between against the stiffening pipe at the edge of a flat washer under the head of the nut, which thereby deforms the clip. When the screw is completely tightened via the nuts, sufficient resistance is created by this action to prevent buckling of the hanger rod within the predetermined distance between clips and the loading force placed thereon.

Finally, it is an aspect of the invention to provide a hanger rod stiffening clip that has a tapered legs so that the clip will stay in positioned until the clip can be tightened.

These and other aspects of the invention will become apparent in light of the detailed description of the invention which follows.

### BRIEF DESCRIPTION OF THE DRAWINGS

FIG. 1 is a plan view of the clip in accordance with the invention.

FIG. 2 is front view of the clip showing the preformed preferred embodiment shape.

FIG. 3 is an end view of the clip shown in FIG. 2.

FIG. 4 is a cross-sectional view of the clip attached around a stiffening pipe and a hanger rod illustrating how the clip can be fully tightened so that the two clamping members can be pinched together via the washers.

FIG. 5 is an isometric view of the invention in place around a stiffening member and a hanger rod.

FIG. 6 is a plan view of clip showing a single pair of opposing screw openings.

FIG. 7 is a front view of the clip shown in FIG. 6.

FIG. 8 is an end view of the clip showing an alternative embodiment of the legs of clip.

FIG. 9 is an end view of the clip showing another alternative embodiment of the legs of the clip.

### DESCRIPTION OF THE PREFERRED EMBODIMENTS

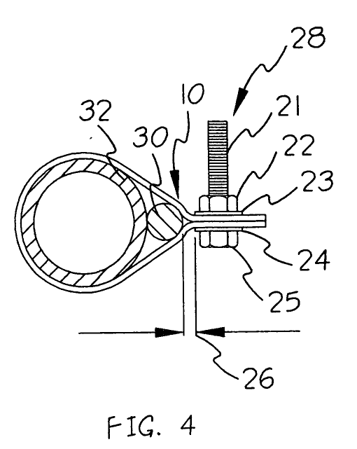

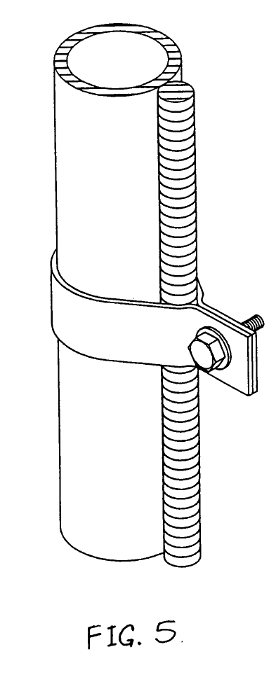

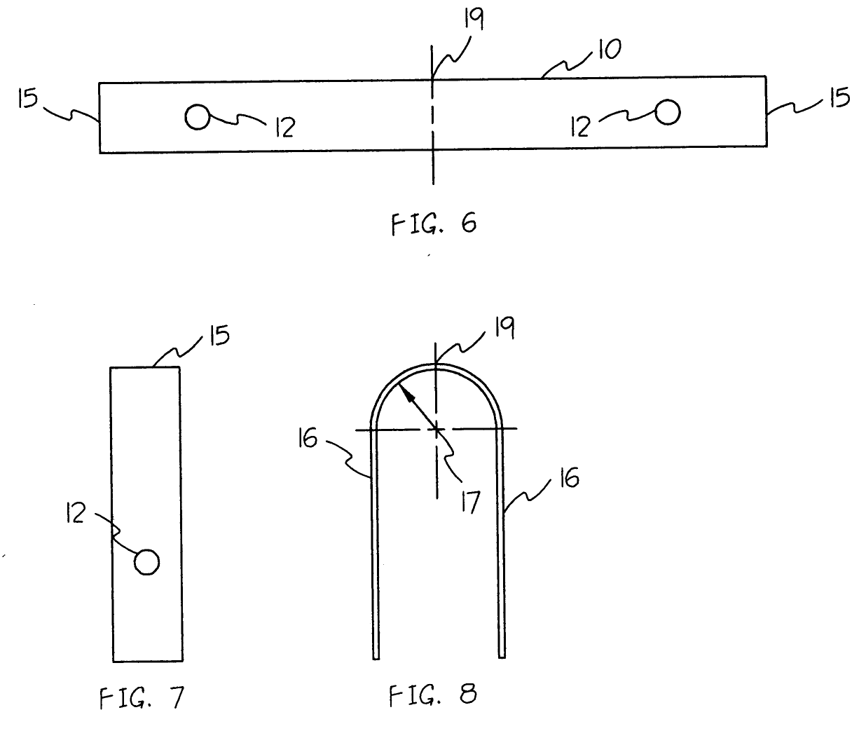

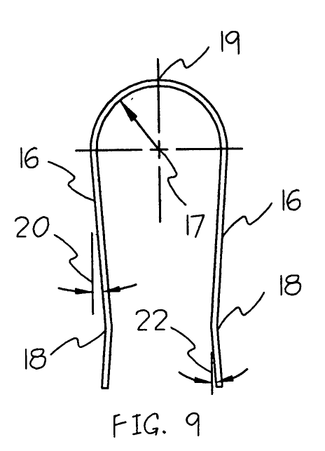

Referring now to FIG. 1, the clip 10 is preferably stamped from 1/16 inch thickness of galvanized sheet material. This thickness will provide sufficient strength for the clip to stabilize the hanger rod 30 (shown in FIG. 4) by way of stiffening member 32 (also shown in FIG. 4) yet be sufficiently malleable to permit easy installation of the clip as is discussed below. In the preferred embodiment, two sets of opposing screw holes 12, 14 are provided. When positioned as noted below, clip 10 is able to accommodate three different sizes of hanger rod 30 . . . 3/8 inch, ½ inch and ⅝ inch. Other sizes of hanger rod could also be used by merely adjusting the positioning the screw holes as described herein.

Clip 10 is preferably 7¼ inches long by ¾ inches wide. Hole set 14 is preferably 0.698 from edge 15. Note that all tolerances are ±0.0005 inches and well within the manufacturing limitations of most stamping equipment. Hole set 12 is preferably 1.062 inches from edge 15. Holes 12 and 14 are preferably 0.261 inches in diameter.

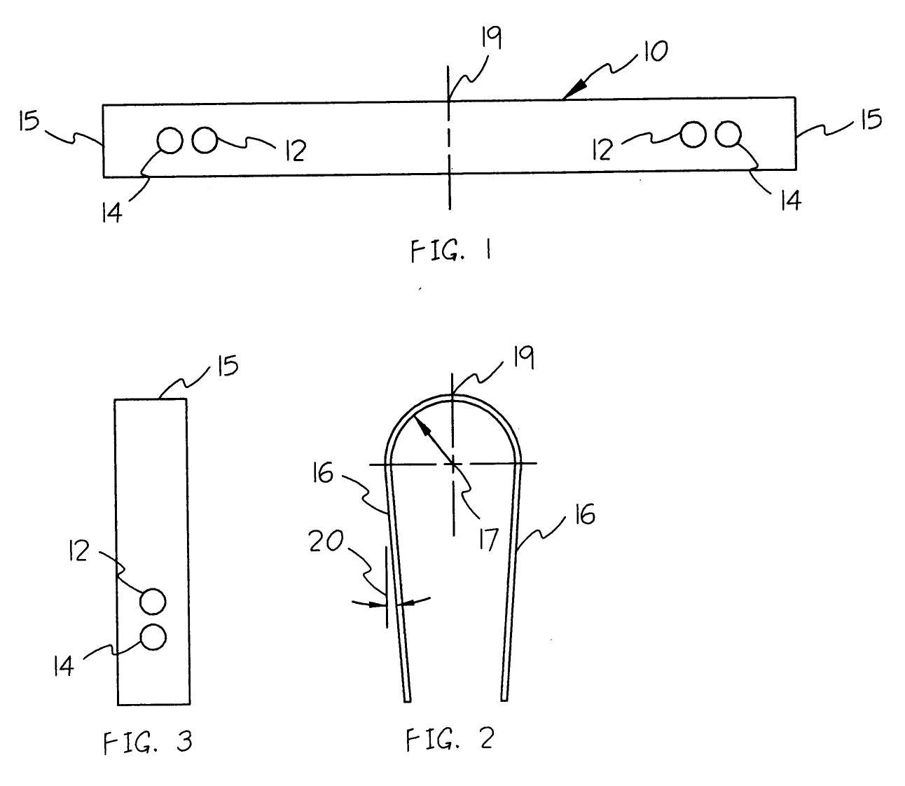

As shown in FIG. 2, the preferred preformed shape of clip 10 is illustrated. The clip 10 is bent in the center 19 of the length to provide substantially U-shape of equal clamping members 16. The radius 17 is 0.650 inches. In the preferred embodiment, the legs are bent inwardly at angle 20 so that the open end of the clip is less than diameter of the circular arc portion of the clip.

As shown in FIG. 8, the clamping members (legs) of the clip extend parallel to one another so that the distance between them always remains the same. In FIG. 9, another embodiment shows each of clamping members 16 tapered at point 18 by forming clamping members inward by angle 20 and outward from point 18 by angle 22. Angle 20 preferably ranges from 3 to 5 degrees and angle 22 ranged from 4 to 6 degrees. In this manner, when clip 10 is placed around hanger rod 30 and stiffener pope 32 prior to tightening as shown in FIG. 4, clip 10 will be held in place while it is securely fastened.

Referring now to FIGS. 4 and 5, it can be seen why the present invention provides much greater strength and stability than prior art devices such as disclosed and claimed by Roth. Hanger rod 30 is disposed between stiffener pipe 32 and locking mechanism 28. Critical dimension 26 is achieved by maintaining a distance 5.162 inches±0.0005 inches between 0.261 inch diameter holes on the flat pattern, prior to forming the “U” shaped clip, and increasing the distance between the holes by 0.364 inches for each ⅛ inch increase in hanger rod diameter. This is achieved by precise hole placement of hole sets 12, 14 with respect to the length of clamping members 16 provides the proper pinching on hanger rod 30. In fact, the inventor has found that a deviation of ±0.001 in hole placement will result in a clip that fails the compression test.

The compression test is conducted by placing an unstiffened hanger rod of a length equal to that prescribed by the American Institute of Steel Construction (AISC) Allowable Stress Design (ASD) buckling formula (Kl/r) between two steel plates. An ever increasing compression load is applied until buckling occurs to establish a base line resistance to buckling under compression force. Loss of pressure on the gauge of the test apparatus indicates that buckling has occurred. In the case of ⅜″ hanger rod, the unstiffened length per the Kl/r formula is 24″. Then a ⅜″ hanger rod 120″ long with rod stiffener clips spaced at a distance that is equal to the maximum length of the unstiffened rod permitted by the Kl/r formula, which is 24″ for ⅜″ rods, is tested.

The 120 inch long hanger rod/stiffener assembly is placed in the test apparatus and subjected to the same test of ever increasing compression pressure until buckling failure is indicated by the sudden loss of pressure on the gauge of the test apparatus. The stiffener clips are successful, if buckling failure pressure on the gauge of the test apparatus is greater than or equal to the compression failure level for the 24 inch rod.

In the ⅜″ hanger rod test, the unstiffened hanger rod failed at 125 psi on the apparatus test gauge and the 120 inch rod stiffened with the invention failed at 325 psi.

As noted above, this embodiment is useful for three different diameter of hanger rod 30. For use with a ⅜ inch hanger rod 30, hole set 12 is used wherein a fully threaded screw (diameter size and thread size ¼-20×1¼) is inserted in the holes and held via standard flat washers 23, 24 and lock nuts 22, 25. While two nuts are preferable, a machine screw well known in the art could be used instead. In fact, any bolt type is suitable as long as the legs of the clip can be drawn tightly together as shown in FIGS. 4 and 5 and is sufficiently strong to withstand the design forces that may be encountered.

For use with a ⅝ inch hanger rod 30, hole set 14 is used as described above. For use with a ½ inch hanger rod 30, one hole of hole set 12 and one hole of the opposing hole set 14 is used. Stiffener member 32 is preferably 1 inch nominal schedule 40 or schedule 10 pipe as both these sizes have the same outside diameter. In this manner, the critical dimension is achieved. To adjust clip 10 for use with other sizes of hanger rods and/or stiffener members, the dimensions would be scaled according to the specifications provided herein.

While certain representative embodiments of the invention have been described herein for the purposes of illustration, it will be apparent to those skilled in the art that modification therein may be made without departure from the spirit and scope of the invention.

What is claimed is:

1. A U-shaped hanger rod clip for holding a stiffening member having an outside diameter in direct contact with a hanger having a diameter wherein said clip protects the hanger against buckling forces, said clip comprising:
a circular arc section having left and right attachment ends and having a diameter that corresponds to the outside diameter of the stiffening member,
a left leg attached to the left attachment end of said circular arc section having inside and outside surfaces and having at least one circular opening positioned at a predetermined position on said left leg such that said predetermined position corresponds to the diameter of the hanger when the hanger is abutted against the stiffening member; and
a right leg attached to the right attachment end of said circular arc section having inside and outside surfaces and having at least one circular opening that is opposite the opening in said left leg and wherein said left and right legs are substantially identical;
a fastening assembly comprising:
a fully threaded screw that is placed through the opposing openings in said legs;
a pair of washers that are placed on the outside surface of said left and right legs respectively such when a nut placed on said screw tightens said fastening assembly with the hanger disposed between the stiffener member and said fastening assembly, said clip is drawn tightly against the stiffening pipe and the hanger by an edge of each respective washer, thus deforming its respective said leg so that at least a portion of the inside of surface of each of said legs are urged tightly against one another, thus protecting the hanger against buckling forces.

2. The clip of claim 1 wherein said right and left legs each have a second pair of opposing circular openings wherein two different diameters of hanger rod can be accommodated by said clip by selecting which pair of opposing openings is selected for use with said fully threaded screw and a third different diameter of hanger rod can be accommodated by selecting one opening from one pair of opposing opening pairs on said right leg and another opening from the other pair of opposing opening pairs on said left leg.

3. The clip of claim 1 wherein said right and left legs each having respective opening ends and wherein the distance between said opening ends of said right and left legs is less than the diameter of said circular arc section.

4. The clip of claim 1 wherein said right and left legs each having respective opening ends and wherein the distance between said opening ends of said right and left legs is substantially the same as the diameter of said circular arc section.

5. The clip of claim 1 wherein said right and left legs each having respective opening ends and wherein each of said legs has an inward section and an outward section meeting at a tapering point adjacent to the opening end of said leg such that the distance between said legs at the tapering point is less than the diameter of said circular arc section wherein said clip can be snapped around the stiffening member and hanger and held in place prior to tightening said fastening assembly.

6. The clip of claim 1 wherein said circular arc section, said left leg and said right leg are integral with one another.

7. The clip of claim 6 wherein clip is made from a single piece of galvanized sheet metal.

8. The clip of claim 1 wherein said fully threaded screw of said fastening assembly has one end selected from the group consisting of a cap head, a fillister head, a binding head, a round head, a pan head, a hexagon head, an acorn nut, a truss head, a socket head, a square head, a fluted head or a nut such as used on the other end of said fully threaded screw to tighten said fastening assembly of said clip onto the hanger and stiffening member.
